(19) United States
(12) Patent Application Publication
(10) Pub. No.: US 2024/0243798 A1
(43) Pub. Date: Jul. 18, 2024

(54) IMPLICIT BEAM SWITCH OR ACTIVATION

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tianyang BAI, Mountain View, CA (US); Wooseok NAM, San Diego, CA (US); Tao LUO, San Diego, CA (US); Junyi LI, Fairless Hills, PA (US)

(21) Appl. No.: 18/561,234

(22) PCT Filed: Jul. 29, 2021
(86) PCT No.: PCT/CN2021/109120

§ 371 Date: Nov. 15, 2023

(51) Int. Cl. H04B 7/06; H04W 72/232

(52) U.S. Cl. CPC H04B 7/06968; H04B 7/0626; H04W 72/232

(57) ABSTRACT

Various aspects of the present disclosure generally relate to wireless communication. In some aspects, a user equipment (UE) may receive a medium access control control element (MAC CE) that indicates one or more transmission configuration indicator (TCI) states to be activated. The UE may receive one or more channel measurement resources (CMRs) that correspond to the one or more TCI states. The UE may transmit a channel state information (CSI) report for a first CMR of the one or more CMRs. The UE may switch to a beam that is quasi-co-located (QCLed) with a first TCI state, of the one or more TCI states, that corresponds to the first CMR, independent of receiving downlink control information (DCI) that indicates switching to the first TCI state. Numerous other aspects are described.

### FIELD OF THE DISCLOSURE

Aspects of the present disclosure generally relate to wireless communication and to techniques and apparatuses for an implicit beam switch or activation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a medium access control control element (MAC CE) that indicates one or more transmission configuration indicator (TCI) states to be activated. The method may include receiving one or more channel measurement resources (CMRs) that correspond to the one or more TCI states. The method may include transmitting a channel state information (CSI) report for a first CMR of the one or more CMRs. The method may include switching to a beam that is quasi-co-located (QCLed) with a first TCI state, of the one or more TCI states, that corresponds to the first CMR, independent of receiving downlink control information (DCI) that indicates switching to the first TCI state.

Some aspects described herein relate to a method of wireless communication performed by a base station. The method may include transmitting a MAC CE that indicates one or more TCI states to be activated. The method may include transmitting one or more CMRs that correspond to the one or more TCI states. The method may include receiving a CSI report for a first CMR of the one or more CMRs. The method may include switching to a beam for a first TCI state, of the one or more TCI states, that corresponds to the first CMR, independent of transmitting DCI that indicates the first TCI state.

Some aspects described herein relate to a method of wireless communication performed by a UE. The method may include receiving one or more CMRs that correspond to one or more TCI states. The method may include activating the one or more TCI states independent of receiving a MAC CE that activates the one or more TCI states. The method may include transmitting a CSI report for a first CMR of the one or more CMRs. The method may include receiving DCI that indicates a first TCI state, of the one or more TCI states, that corresponds to the first CMR. The method may include switching to a beam that is QCLed with the first TCI state.

Some aspects described herein relate to a method of wireless communication performed by a base station. The method may include transmitting one or more CMRs that correspond to one or more TCI states. The method may include receiving, independent of transmitting a MAC CE, a CSI report for a first CMR of the one or more CMRs. The method may include transmitting DCI that indicates a first TCI state, of the one or more TCI states, that corresponds to the first CMR. The method may include switching to a beam for the first TCI state.

Some aspects described herein relate to a UE for wireless communication. The UE may include memory and one or more processors coupled to the memory. The one or more processors are configured to receive a MAC CE that indicates one or more TCI states to be activated. The one or more processors are configured to receive one or more CMRs that correspond to the one or more TCI states. The one or more processors are configured to transmit a CSI report for a first CMR of the one or more CMRs. The one or more processors are configured to switch to a beam that is QCLed with a first TCI state, of the one or more TCI states, that corresponds to the first CMR, independent of receiving DCI that indicates switching to the first TCI state.

Some aspects described herein relate to a base station for wireless communication. The base station may include memory and one or more processors coupled to the memory. The one or more processors are configured to transmit a MAC CE that indicates one or more TCI states to be activated and transmit one or more CMRs that correspond to the one or more TCI states. The one or more processors are configured to receive a CSI report for a first CMR of the one or more CMRs and switch to a beam for a first TCI state, of the one or more TCI states, that corresponds to the first CMR, independent of transmitting DCI that indicates the first TCI state.

Some aspects described herein relate to a UE for wireless communication. The UE may include memory and one or more processors coupled to the memory. The one or more processors are configured to receive one or more CMRs that correspond to one or more TCI states and activate the one or more TCI states independent of receiving a MAC CE that activates the one or more TCI states. The one or more processors are configured to transmit a CSI report for a first CMR of the one or more CMRs and receive DCI that indicates a first TCI state, of the one or more TCI states, that corresponds to the first CMR. The one or more processors are configured to switch to a beam that is QCLed with the first TCI state.

Some aspects described herein relate to a base station for wireless communication. The base station may include memory and one or more processors coupled to the memory. The one or more processors are configured to transmit one or more CMRs that correspond to one or more TCI states and receive, independent of transmitting a MAC CE, a CSI report for a first CMR of the one or more CMRs. The one or more processors are configured to transmit DCI that indicates a first TCI state, of the one or more TCI states, that corresponds to the first CMR. The one or more processors are configured to switch to a beam for the first TCI state.

Some aspects described herein relate to a non-transitory computer-readable medium that stores one or more instructions for wireless communication by a UE. The one or more instructions, when executed by one or more processors of the UE, may cause the UE to receive a MAC CE that indicates one or more TCI states to be activated. The one or more instructions, when executed by one or more processors of the UE, may cause the UE to receive one or more CMRs that correspond to the one or more TCI states. The one or more instructions, when executed by one or more processors of the UE, may cause the UE to transmit a CSI report for a first CMR of the one or more CMRs. The one or more instructions, when executed by one or more processors of the UE, may cause the UE to switch to a beam that is QCLed with a first TCI state, of the one or more TCI states, that corresponds to the first CMR, independent of receiving DCI that indicates switching to the first TCI state.

Some aspects described herein relate to a non-transitory computer-readable medium that stores one or more instructions for wireless communication by a base station. The one or more instructions, when executed by one or more processors of the base station, may cause the base station to transmit a MAC CE that indicates one or more TCI states to be activated. The one or more instructions, when executed by one or more processors of the base station, may cause the base station to transmit one or more CMRs that correspond to the one or more TCI states. The one or more instructions, when executed by one or more processors of the base station, may cause the base station to receive a CSI report for a first CMR of the one or more CMRs. The one or more instructions, when executed by one or more processors of the base station, may cause the base station to switch to a beam for a first TCI state, of the one or more TCI states, that corresponds to the first CMR, independent of transmitting DCI that indicates the first TCI state.

Some aspects described herein relate to a non-transitory computer-readable medium that stores one or more instructions for wireless communication. The one or more instructions, when executed by one or more processors of the UE, may cause the UE to receive one or more CMRs that correspond to one or more TCI states. The one or more instructions, when executed by one or more processors of the UE, may cause the UE to activate the one or more TCI states independent of receiving a MAC CE that activates the one or more TCI states. The one or more instructions, when executed by one or more processors of the UE, may cause the UE to transmit a CSI report for a first CMR of the one or more CMRs. The one or more instructions, when executed by one or more processors of the UE, may cause the UE to receive DCI that indicates a first TCI state, of the one or more TCI states, that corresponds to the first CMR. The one or more instructions, when executed by one or more processors of the UE, may cause the UE to switch to a beam that is QCLed with the first TCI state.

Some aspects described herein relate to a non-transitory computer-readable medium that stores one or more instructions for wireless communication by a base station. The one or more instructions, when executed by one or more processors of the base station, may cause the base station to transmit one or more CMRs that correspond to one or more TCI states. The one or more instructions, when executed by one or more processors of the base station, may cause the base station to receive, independent of transmitting a MAC CE, a CSI report for a first CMR of the one or more CMRs. The one or more instructions, when executed by one or more processors of the base station, may cause the base station to transmit DCI that indicates a first TCI state, of the one or more TCI states, that corresponds to the first CMR. The one or more instructions, when executed by one or more processors of the base station, may cause the base station to switch to a beam for the first TCI state.

Some aspects described herein relate to an apparatus for wireless communication. The apparatus may include means for receiving a MAC CE that indicates one or more TCI states to be activated. The apparatus may include means for receiving one or more CMRs that correspond to the one or more TCI states. The apparatus may include means for transmitting a CSI report for a first CMR of the one or more CMRs. The apparatus may include means for switching to a beam that is QCLed with a first TCI state, of the one or more TCI states, that corresponds to the first CMR, independent of receiving DCI that indicates switching to the first TCI state.

Some aspects described herein relate to an apparatus for wireless communication. The apparatus may include means for transmitting a MAC CE that indicates one or more TCI states to be activated. The apparatus may include means for transmitting one or more CMRs that correspond to the one or more TCI states. The apparatus may include means for receiving a CSI report for a first CMR of the one or more CMRs. The apparatus may include means for switching to a beam for a first TCI state, of the one or more TCI states, that corresponds to the first CMR, independent of transmitting DCI that indicates the first TCI state.

Some aspects described herein relate to an apparatus for wireless communication. The apparatus may include means for receiving one or more CMRs that correspond to one or more TCI states. The apparatus may include means for activating the one or more TCI states independent of receiving a MAC CE that activates the one or more TCI states. The apparatus may include means for transmitting a CSI report for a first CMR of the one or more CMRs. The apparatus may include means for receiving DCI that indicates a first TCI state, of the one or more TCI states, that corresponds to the first CMR. The apparatus may include means for switching to a beam that is QCLed with the first TCI state.

Some aspects described herein relate to an apparatus for wireless communication. The apparatus may include means for transmitting one or more CMRs that correspond to one or more TCI states. The apparatus may include means for receiving, independent of transmitting a MAC CE, a CSI report for a first CMR of the one or more CMRs. The apparatus may include means for transmitting DCI that indicates a first TCI state, of the one or more TCI states, that corresponds to the first CMR. The apparatus may include means for switching to a beam for the first TCI state.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of using beams for communications between a base station and a UE, in accordance with the present disclosure.

FIG. 4 is a diagram illustrating an example associated with beam switching, in accordance with the present disclosure.

FIG. 5 is a diagram illustrating an example associated with implicit beam switching, in accordance with the present disclosure.

FIG. 6 is a diagram illustrating an example associated with implicit beam switching, in accordance with the present disclosure.

FIG. 7 is a diagram illustrating an example associated with implicit beam switching, in accordance with the present disclosure.

FIG. 8 is a diagram illustrating an example associated with implicit beam switching, in accordance with the present disclosure.

FIG. 9 is a diagram illustrating an example associated with implicit transmission configuration indicator (TCI) state activation, in accordance with the present disclosure.

FIG. 10 is a diagram illustrating an example associated with implicit TCI state activation, in accordance with the present disclosure.

FIG. 11 is a diagram illustrating an example process performed, for example, by a UE, in accordance with the present disclosure.

FIG. 12 is a diagram illustrating an example process performed, for example, by a base station, in accordance with the present disclosure.

FIG. 13 is a diagram illustrating an example process performed, for example, by a UE, in accordance with the present disclosure.

FIG. 14 is a diagram illustrating an example process performed, for example, by a base station, in accordance with the present disclosure.

FIGS. 15-18 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

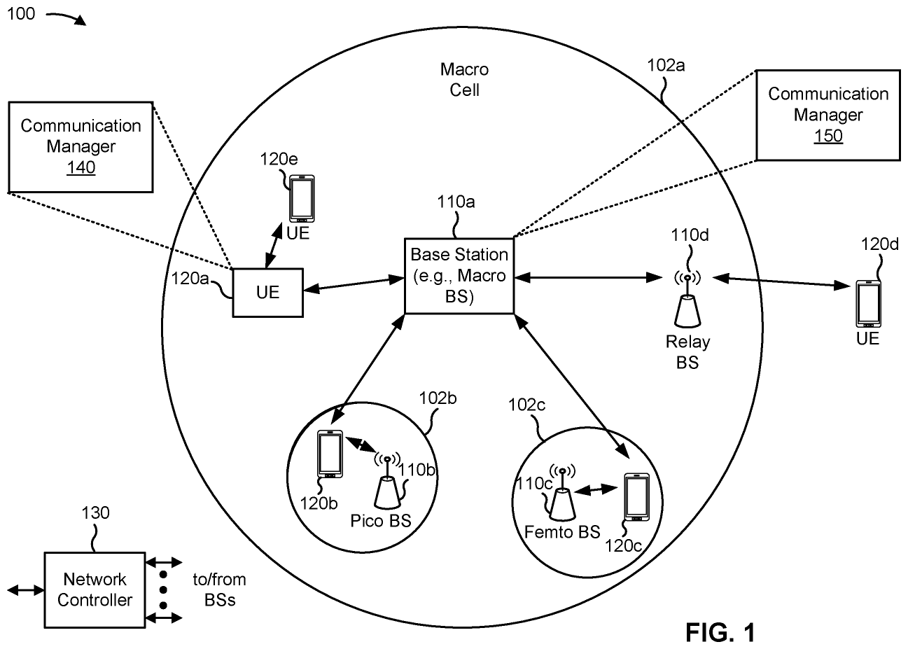

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a medium access control control element (MAC CE) that indicates one or more transmission configuration indicator (TCI) states to be activated and receive one or more channel measurement resources (CMRs) that correspond to the one or more TCI states. The communication manager 140 may transmit a channel state information (CSI) report for a first CMR of the one or more CMRs and switch to a beam that is quasi-co-located (QCLed) with a first TCI state, of the one or more TCI states, that corresponds to the first CMR, independent of receiving downlink control information (DCI) that indicates switching to the first TCI state. Additionally, or alternatively, the communication manager 140 may perform one or more other operations described herein.

In some aspects, the base station 110 may include a communication manager 150. As described in more detail elsewhere herein, the communication manager 150 may transmit a MAC CE that indicates one or more TCI states to be activated and transmit one or more CMRs that correspond to the one or more TCI states. The communication manager 150 may receive a CSI report for a first CMR of the one or more CMRs and switch to a beam for a first TCI state, of the one or more TCI states, that corresponds to the first CMR, independent of transmitting DCI that indicates the first TCI state. Additionally, or alternatively, the communication manager 150 may perform one or more other operations described herein.

In some aspects, the UE 120 may include a communication manager 140. As described in more detail elsewhere herein, the communication manager 140 may receive one or more CMRs that correspond to one or more TCI states and activate the one or more TCI states independent of receiving a MAC CE that activates the one or more TCI states. The communication manager 140 may transmit a CSI report for a first CMR of the one or more CMRs; receive DCI that indicates a first TCI state, of the one or more TCI states, that corresponds to the first CMR and switch to a beam that is QCLed with the first TCI state. Additionally, or alternatively, the communication manager 140 may perform one or more other operations described herein.

In some aspects, the base station 110 may include a communication manager 150. As described in more detail elsewhere herein, the communication manager 150 may transmit one or more CMRs that correspond to one or more TCI states and receive, independent of transmitting a MAC CE, a CSI report for a first CMR of the one or more CMRs. The communication manager 150 may transmit DCI that indicates a first TCI state, of the one or more TCI states, that corresponds to the first CMR and switch to a beam for the first TCI state. Additionally, or alternatively, the communication manager 150 may perform one or more other operations described herein.

As indicated above, FIG. 1 is provided as an example. Other examples may differ from what is described with regard to FIG. 1.

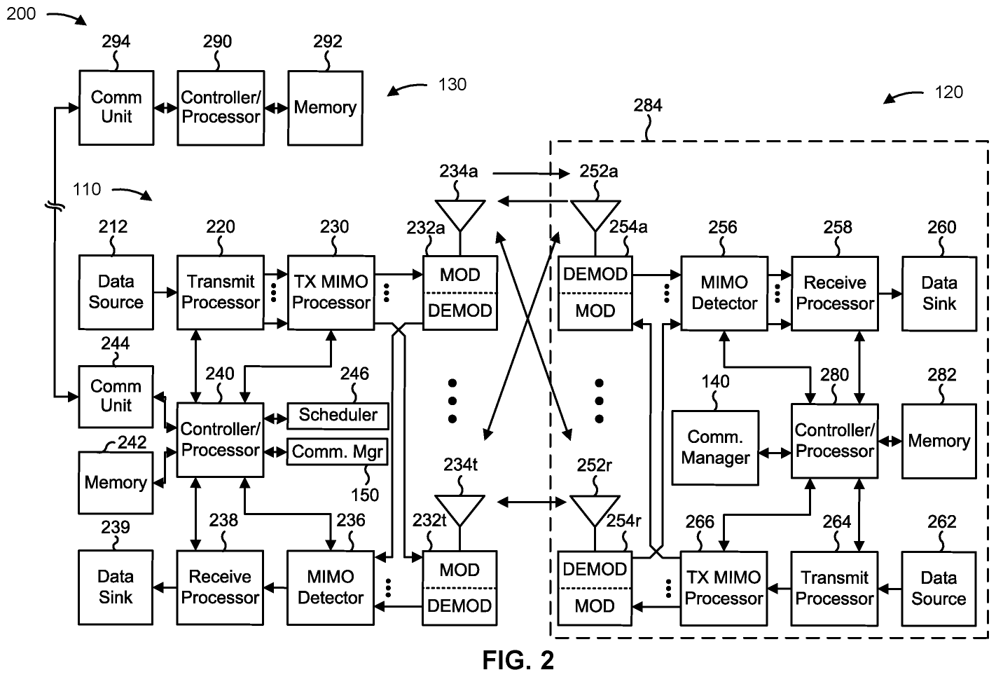

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 1-18).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 1-18).

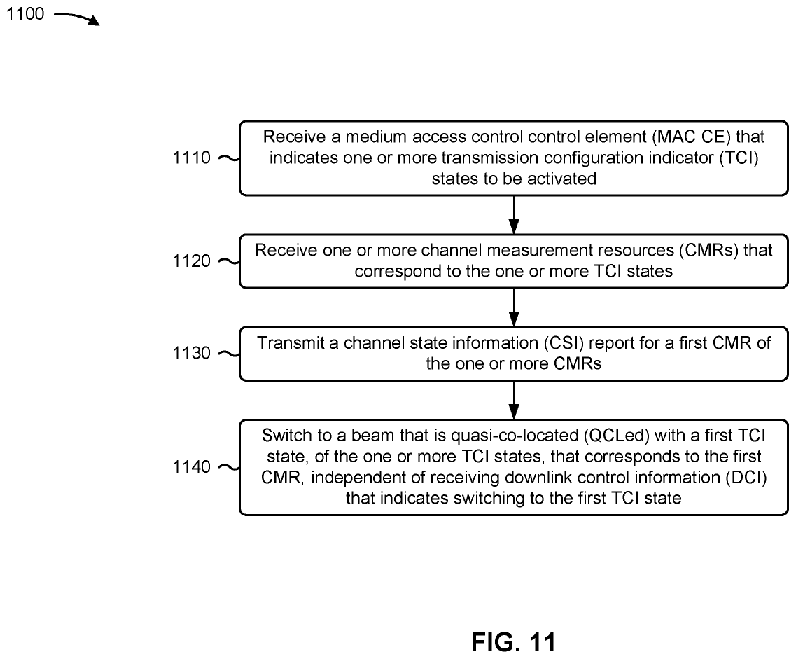

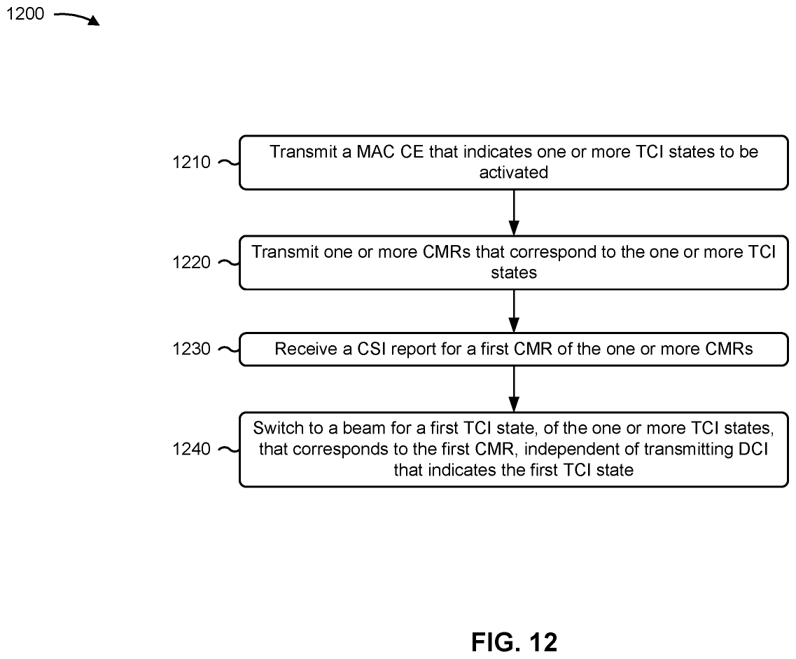

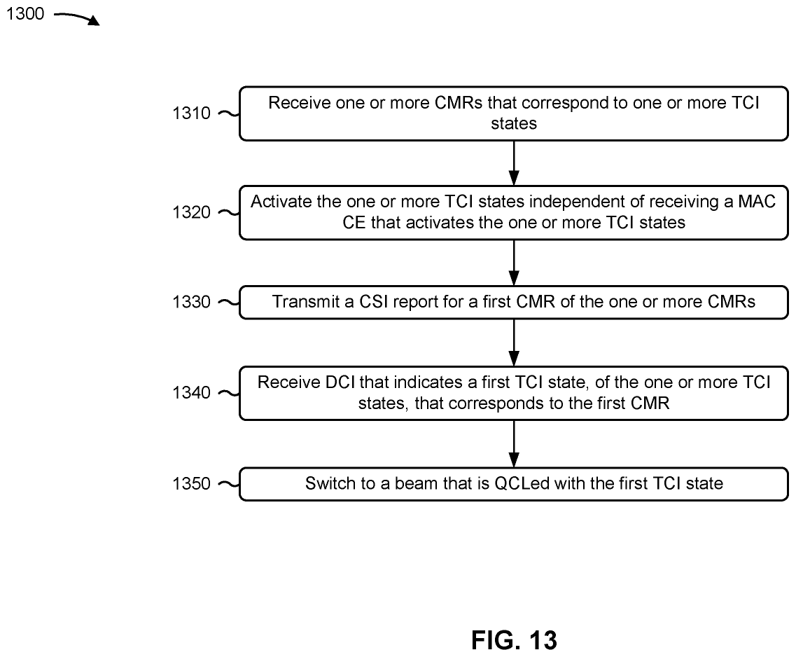

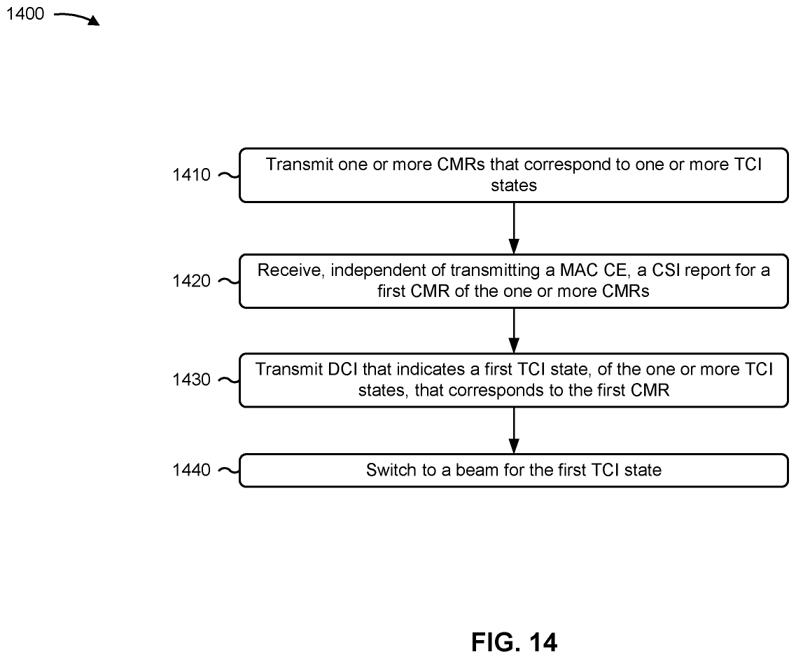

The controller/processor 240 of the base station 110, the controller/processor 280 of the UE 120, and/or any other component(s) of FIG. 2 may perform one or more techniques associated with implicit beam (TCI state) activation or implicit beam switching, as described in more detail elsewhere herein. For example, the controller/processor 240 of the base station 110, the controller/processor 280 of the UE 120, and/or any other component(s) of FIG. 2 may perform or direct operations of, for example, process 1100 of FIG. 11, process 1200 of FIG. 12, process 1300 of FIG. 13, process 1400 or FIG. 14, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1100 of FIG. 11, process 1200 of FIG. 12, process 1300 of FIG. 13, process 1400 or FIG. 14, and/or other processes as described herein. In some examples, executing instructions may include running the instructions, converting the instructions, compiling the instructions, and/or interpreting the instructions, among other examples.

In some aspects, the UE 120 includes means for receiving a MAC CE that indicates one or more TCI states to be activated, means for receiving one or more CMRs that correspond to the one or more TCI states, means for transmitting a CSI report for a first CMR of the one or more CMRs, and/or means for switching to a beam that is QCLed with a first TCI state, of the one or more TCI states, that corresponds to the first CMR, independent of receiving DCI that indicates switching to the first TCI state. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting a MAC CE that indicates one or more TCI states to be activated, means for transmitting one or more CMRs that correspond to the one or more TCI states, means for receiving a CSI report for a first CMR of the one or more CMRs, and/or means for switching to a beam for a first TCI state, of the one or more TCI states, that corresponds to the first CMR, independent of transmitting DCI that indicates the first TCI state. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE 120 includes means for receiving one or more CMRs that correspond to one or more TCI states, means for activating the one or more TCI states independent of receiving a MAC CE that activates the one or more TCI states, means for transmitting a CSI report for a first CMR of the one or more CMRs, means for receiving DCI that indicates a first TCI state, of the one or more TCI states, that corresponds to the first CMR, and/or means for switching to a beam that is QCLed with the first TCI state. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting one or more CMRs that correspond to one or more TCI states, means for receiving, independent of transmitting a MAC CE, a CSI report for a first CMR of the one or more CMRs, means for transmitting DCI that indicates a first TCI state, of the one or more TCI states, that corresponds to the first CMR, and/or means for switching to a beam for the first TCI state. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

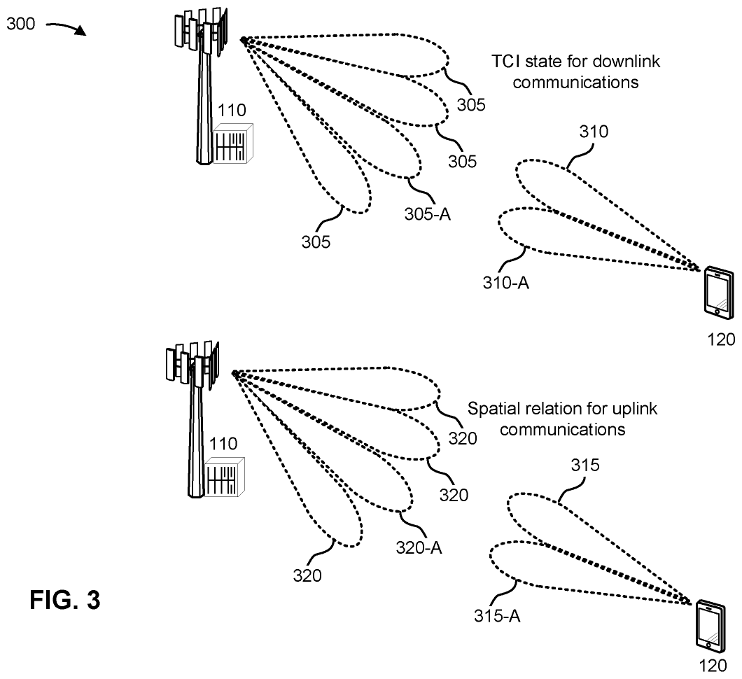

FIG. 3 is a diagram illustrating an example 300 of using beams for communications between a base station and a UE, in accordance with the present disclosure. As shown in FIG. 3, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 305.

The UE 120 may attempt to receive downlink transmissions via one or more UE receive beams 310, which may be configured using different beamforming parameters at receive circuitry of the UE 120. The UE 120 may identify a particular BS transmit beam 305, shown as BS transmit beam 305-A, and a particular UE receive beam 310, shown as UE receive beam 310-A, that provide relatively favorable performance (for example, that have a best channel quality of the different measured combinations of BS transmit beams 305 and UE receive beams 310). In some examples, the UE 120 may transmit an indication of which BS transmit beam 305 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 305-A and the UE receive beam 310-A), which may be further refined and maintained in accordance with one or more established beam refinement procedures.

A downlink beam, such as a BS transmit beam 305 or a UE receive beam 310, may be associated with a TCI states state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each BS transmit beam 305 may be associated with a synchronization signal block (SSB), and the UE 120 may indicate a preferred BS transmit beam 305 by transmitting uplink transmissions in resources of the SSB that are associated with the preferred BS transmit beam 305. A particular SSB may have an associated TCI state (for example, for an antenna port or for beamforming). The base station 110 may, in some examples, indicate a downlink BS transmit beam 305 based at least in part on antenna port QCL properties that may be indicated by the TCI state. A TCI state may be associated with a CMR, which may include a reference signal of a downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 310 at the UE 120. Thus, the UE 120 may select a corresponding UE receive beam 310 from a set of BPLs based at least in part on the base station 110 indicating a BS transmit beam 305 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a physical downlink shared channel (PDSCH). The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the base station 110 using a directional UE transmit beam, and the base station 110 may receive the transmission using a directional BS receive beam. Each UE transmit beam may have an associated beam identifier (ID), beam direction, or beam symbols, among other examples. The UE 120 may transmit uplink communications via one or more UE transmit beams 315.

The base station 110 may receive uplink transmissions via one or more BS receive beams 320. The base station 110 may identify a particular UE transmit beam 315, shown as UE transmit beam 315-A, and a particular BS receive beam 320, shown as BS receive beam 320-A, that provide relatively favorable performance (for example, that have a best channel quality of the different measured combinations of UE transmit beams 315 and BS receive beams 320). In some examples, the base station 110 may transmit an indication of which UE transmit beam 315 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 315-A and the BS receive beam 320-A), which may be further refined and maintained in accordance with one or more established beam refinement procedures. An uplink beam, such as a UE transmit beam 315 or a BS receive beam 320, may be associated with a spatial relation. A spatial relation may indicate a directionality or a characteristic of the uplink beam, similar to one or more QCL properties, as described above.

A downlink channel may include a PDCCH that carries DCI, a PDSCH that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

A downlink reference signal may include an SSB or a CSI-RS, among other examples. An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report a CMR and/or channel estimation parameters to the base station 110 (e.g., in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

An uplink reference signal may include a sounding reference signal (SRS), among other examples. An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

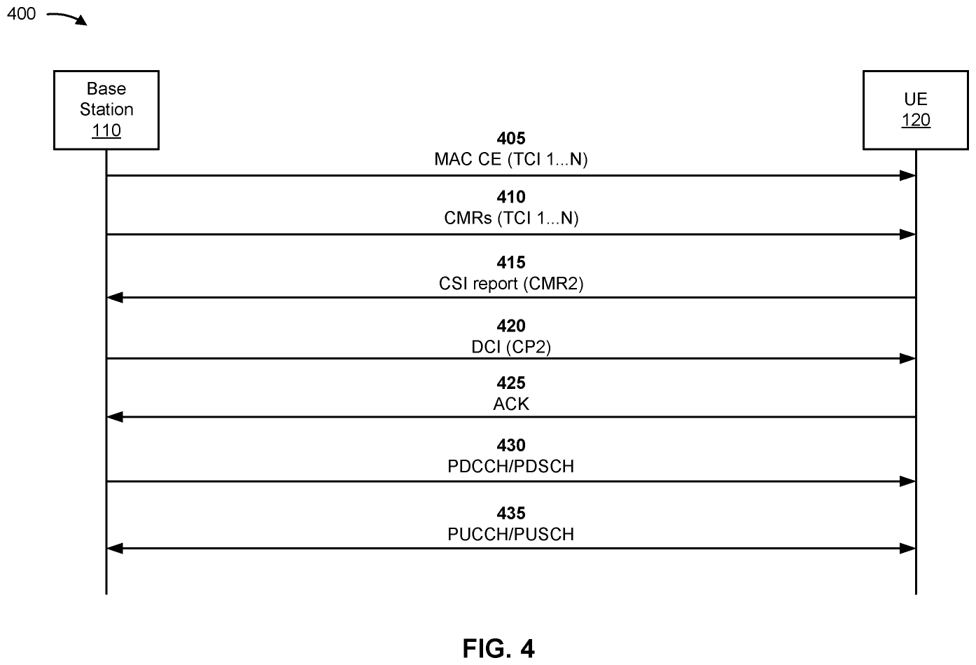

FIG. 4 is a diagram illustrating an example 400 associated with beam switching, in accordance with the present disclosure. As shown in FIG. 4, a base station 110 and a UE 120 may communicate with one another.

The UE 120 may switch beams based on an explicit signal in DCI. Example 400 shows an explicit beam switch with DCI. As shown by reference number 405, the base station 110 may transmit a MAC CE that indicates one or more TCI states to be activated. As shown by reference number 410, the base station 110 may transmit one or more CMRs associated with the activated TCI states. The UE 120 may measure the one or more CMRs and select a beam based on the CMR measurements (e.g., reference signal identified by CMR2). As shown by reference number 415, the UE 120 may transmit a CSI report that indicates CMR2, which may correspond to TCI state 2 (TCI2).

The base station 110 may determine that the UE is to switch to a beam that corresponds to TCI2. The base station may generate DCI with an indication of TCI codepoint 2 (e.g., 2^{nd} TCI codepoint in TCI indication field of DCI), which is mapped to TCI2. As shown by reference number 420, the base station 110 may transmit the DCI. As shown by reference number 425, the UE 120 may transmit an ACK for the DCI. As shown by reference number 430, the base station 110 and the UE 120 may switch to the beam that corresponds to (or is QCLed with) TCI2 for physical channels and reference signals applicable to TCI2. As shown by reference number 430, the UE 120 may use the beam for PDCCH or PDSCH communications. As shown by reference number 435, the UE 120 may use the beam for PUCCH or PUSCH communications.

As indicated above, FIG. 4 is provided as an example. Other examples may differ from what is described with respect to FIG. 4.

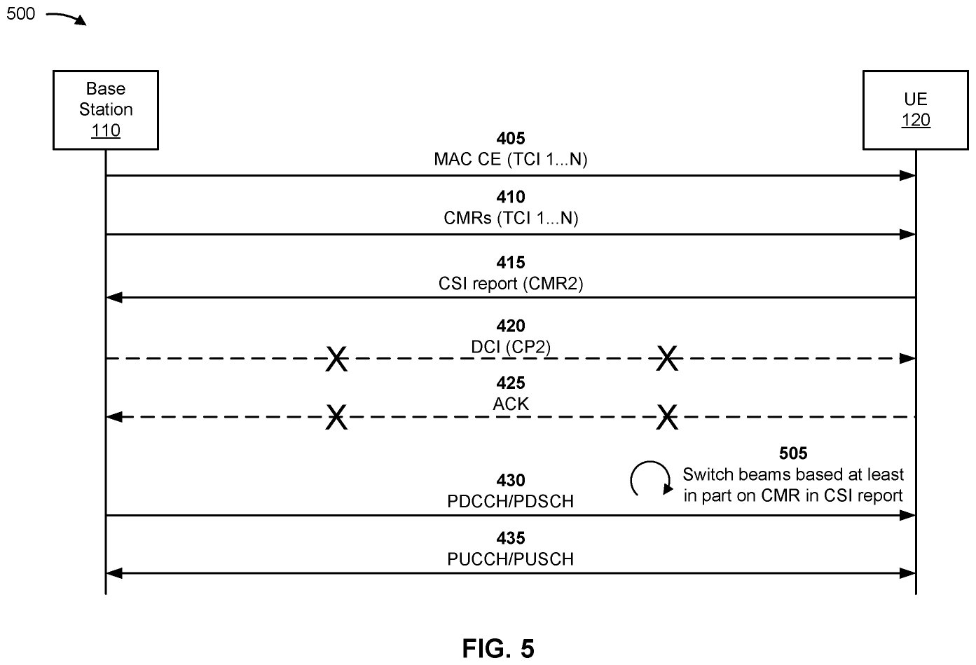

FIG. 5 is a diagram illustrating an example 500 associated with implicit beam switching, in accordance with the present disclosure. As shown in FIG. 5, a base station 110 and a UE 120 may communicate with one another. FIG. 5 refers to operations shown in FIG. 4.

According to various aspects described herein, a UE may perform implicit beam switching by switching beams (or beam groups) without DCI that includes TCI state or spatial relation information for switching beams. For example, as shown by reference number 505, the UE 120 may switch to a beam that is QCLed with a TCI state that corresponds to a CMR (CMR2) reported in the CSI report as part of reference number 415. That is, the UE 120 may switch to the beam independent of receiving the DCI shown by reference number 420. Accordingly, the UE 120 may eliminate the overhead of the DCI of reference number 420 and the ACK of reference number 425. The beam switch is implicit because the UE switches to a beam QCLed with the TCI state that corresponds to the reported CMR and does not rely on DCI to indicate the beam to which the UE is to switch.

If signaling can be reduced for implicit beam switching, overhead and latency may be reduced. Removing DCI signaling for TCI state or spatial relation information may save more overhead than removing RRC or MAC CE signaling. For example, if RRC signaling is used to indicate TCI state or spatial relation information (e.g., for CSI-RS and periodic/aperiodic SRS) or to indicate a unified TCI state (e.g., for CSI-RS for beam management, tracking, or periodic/aperiodic SRS for beam management), removing such RRC signaling does not save overhead or reduce latency. MAC CE signaling may be used to indicate TCI state or spatial relation information (e.g., for PDCCH, PUCCH, semi-periodic CSI-RS, semi-periodic/aperiodic SRS, or indicating activated TCI states for PDSCH) or to indicate a unified TCI state (e.g., for CSI-RS for beam management, tracking, or periodic/aperiodic SRS for beam management). However, removing the MAC CE signaling may not save significant overhead or reduce latency. DCI may be used to indicate TCI state or spatial relation information (e.g., for dynamic grant (DG)-PDSCH/PUSCH) and or to indicate a unified TCI state (e.g., for PDCCH/DG-PDSCH, DG-PUSCH/PUCCH, or CSI/SRS). By removing the DCI signaling, more significant overhead may be saved and latency may be reduced.

As indicated above, FIG. 5 is provided as an example. Other examples may differ from what is described with regard to FIG. 5.

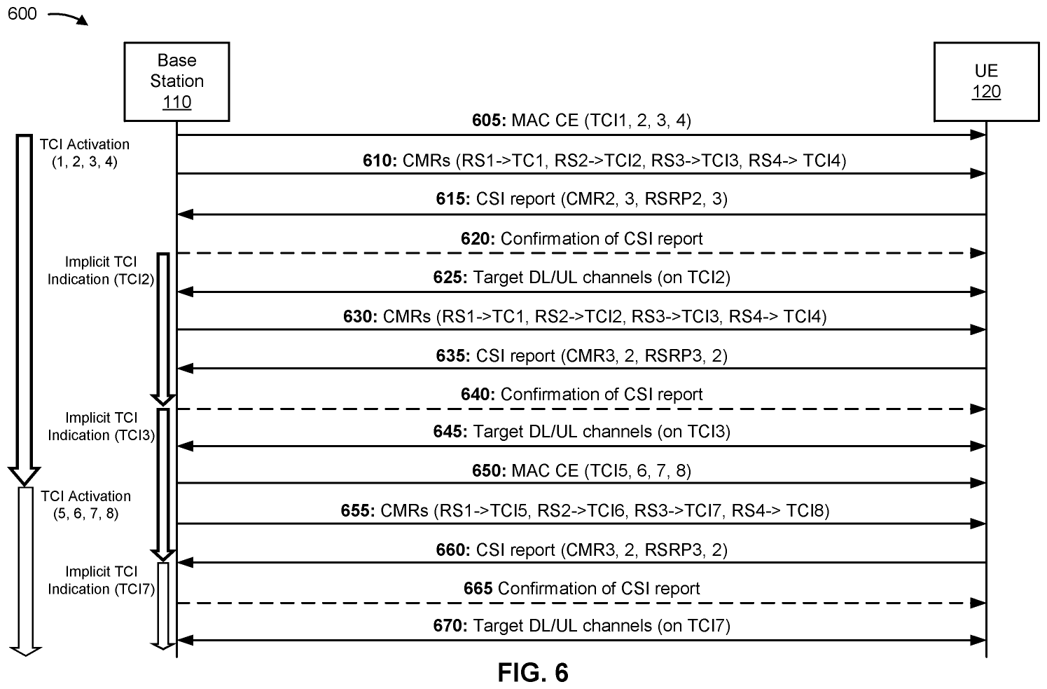

FIG. 6 is a diagram illustrating an example 600 associated with implicit beam switching, in accordance with the present disclosure. As shown in FIG. 6, a base station 110 and a UE 120 may communicate with one another.

In some aspects, TCI states may have a same set of target channels, which may be uplink channels and/or downlink channels. Example 600 shows that TCI states may apply to both uplink channels and downlink channels. For example, the TCI states may be joint TCIs, and may apply to at least UE dedicated channels, such as PDCCH, PDCCH, PUCCH, and PUSCH. As shown by reference number 605, the base station 110 may transmit a MAC CE to activate TCI states TCI1, TCI2, TCI3, and TCI4. As shown by reference number 610, the base station 110 may transmit a set of CMR resources to the UE, which are configured for the implicit beam switch (implicit TCI indication). The CMR resources and the activated TCIs may be one-to-one mapped. The TCI state for each CMR resource may be updated by a TCI activation MAC CE. For example, a first reference signal (RS1) may correspond to TCI1, a second reference signal (RS2) may correspond to TCI2, a third reference signal (RS3) may correspond to TCI3, and a fourth reference signal (RS4) may correspond to TCI4.

As shown by reference number 615, the UE 120 may transmit a CSI report that indicates one or more CMRs that were indicated as part of reference number 610. For example, the CSI report may indicate CMR2 and CMR3 in an order that indicates that TCI states corresponding to both CMR2 and CMR3 (TCI2, TCI3) may be used and qualified for the implicit TCI indication. When multiple CMRs have the same set of applicable channels, one of the CMRs may be chosen based at least in part on one or more predetermined rules. For example, the first reported CMR in the CSI report, or the CMR mapped with the lowest TCI ID, or lowest TCI codepoint ID may be preferred. In the example 600, CMR2 (TCI2) is preferred over CMR3 (TCI3).

As shown by reference number 620, the base station 110 may transmit a confirmation of the CSI report. In some aspects, the confirmation of the CSI report may be DCI indicating TCI2 to the UE 120. If the UE 120 receives DCI indicating TCI2 within a time window after the CSI report, the UE 120 may further apply the implicit TCI indication based at least in part on the CSI report. In some aspects, the UE 120 may receive DCI indicating another TCI, rather than TCI2, that has the same set of applicable channels as TCI2. The UE 120 may cancel the implicit TCI indication based at least in part on the CSI report. In some aspects, the UE 120 may apply the implicit TCI indication based at least in part on the CSI report after a time offset (e.g., several slots or milliseconds) from the end of the transmission of the CSI report. In some aspects, the UE 120 may apply the implicit TCI indication based at least in part on the CSI report after some time offset (e.g., several slots or milliseconds) from the end of the reception of the confirmation for the CSI report. The confirmation may be an optional step that is an implicit TCI indication for UE 120 to use a beam that corresponds to TCI2. As shown by reference number 625, the base station 110 and the UE 120 may use a beam that corresponds to (is QCLed with) TCI2 for uplink channels and downlink channels.

The base station 110 may transmit another set of CMRs, as shown by reference number 630. In this case, there are no changes. The UE 120 may measure the CMRs and transmit a CSI report, as shown by reference number 635. In this CSI report, the order of the CMRs has changed (CMR3, CMR2 and RSRP3, RSRP2). As shown by reference number 640, the base station 110 may transmit a confirmation of the CSI report, which may implicitly indicate use of TCI3. As shown by reference number 645, the base station 110 and the UE 120 may use a beam that corresponds to (is QCLed with) TCI3 for uplink and downlink channels.

The base station 110 may activate other TCI states. As shown by reference number 650, the base station 110 may transmit a MAC CE that activates TCI5, TCI6, TCI7, and TCI8. As shown by reference number 655, the base station 110 may transmit a new set of CMRs, where RS1 now corresponds to TCI5, RS2 corresponds to TCI6, RS3 corresponds to TCI7, and RS4 corresponds to TCI8. As shown by reference number 660, the UE 120 may transmit a CSI report with an order of CMR3 and CMR2. As shown by reference number 665, the base station 110 may transmit a confirmation of the CSI report to implicitly indicate TCI7. TCI7 corresponds to CMR3. As shown by reference number 670, the base station and the UE 120 may use a beam that corresponds to TCI7 to transmit communications on uplink channels and downlink channels. By switching to a beam that is QCLed with a TCI state that corresponds to a reported CMR, the UE 120 may switch to the beam without relying on (and is independent of) DCI indicating that the UE 120 is to switch to a beam QCLed with TCI7 (and the accompanying ACK). As a result, the base station 110 and the UE 120 may conserve signaling resources and reduce latency that would otherwise be attributed to the time taken for the DCI and the ACK.

As indicated above, FIG. 6 is provided as an example. Other examples may differ from what is described with regard to FIG. 6.

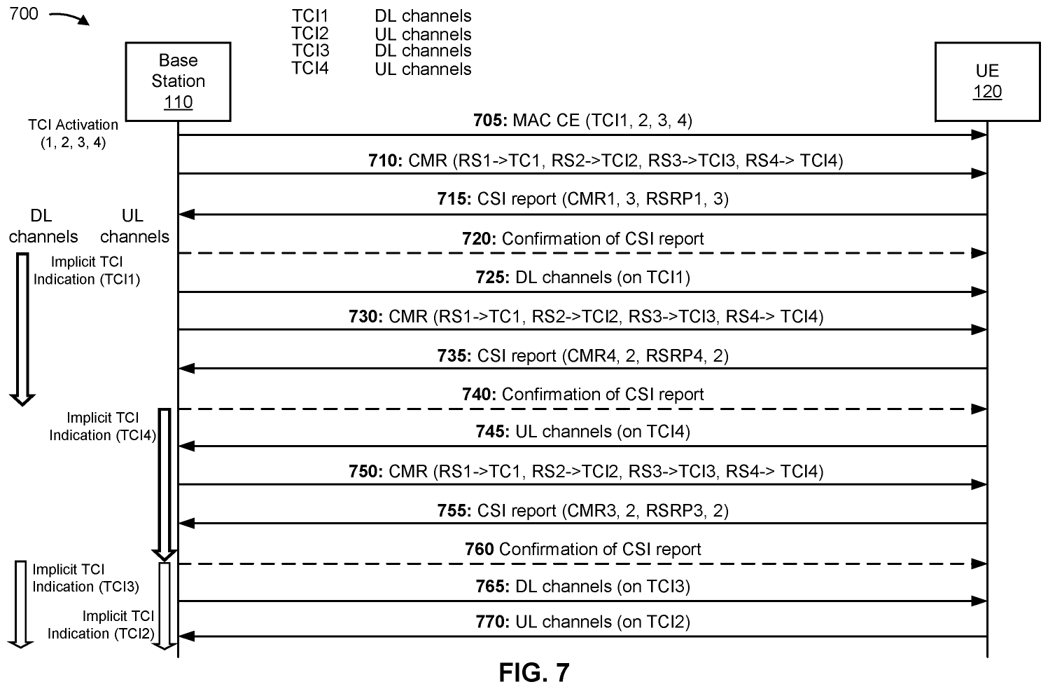

FIG. 7 is a diagram illustrating an example 700 associated with implicit beam switching, in accordance with the present disclosure. As shown in FIG. 7, a base station 110 and a UE 120 may communicate with one another.

In some aspects, the TCI state may be a unified TCI state (Release 17). The unified TCI state may indicate which uplink channels and/or downlink channels to update with the TCI state. The channels for a unified TCI state may be preconfigured between the UE 120 and the base station 110. For example, a TCI state QCLed to RS1 may be activated for a first TCI codepoint for DCI, due to a one-to-one mapping between reference signals and TCI states, and/or a one-to-one mapping between TCI states and TCI codepoints for DCI. The quantity of activated TCI states may be equal to the quantity of reported reference signals. Each TCI codepoint may not have a pair of uplink and downlink TCI states. For example, TCI1 and TCI2 may be downlink TCI states that are used for downlink channels while TCI2 and TCI4 may be uplink TCI states that used for uplink channels. Example 700 shows different TCI states for different sets of target channels.

As shown by reference number 705, the base station 110 may transmit a MAC CE to activate TCI states TCI1, TCI2, TCI3, and TCI4. As shown by reference number 710, the base station 110 may transmit CMR resources. For example, RS1 may correspond to TCI1, RS2 may correspond to TCI2, RS3 may correspond to TCI3, and RS4 may correspond to TCI4.

As shown by reference number 715, the UE 120 may transmit a CSI report that indicates one or more CMRs that were indicated as part of reference number 710. For example, the CSI report may indicate CMR1 and CMR3 in order (e.g., with RSRP1, RSRP3). As shown by reference number 720, the base station 110 may transmit a confirmation of the CSI report. As shown by reference number 725, the base station 110 and the UE 120 may use a beam that corresponds to (is QCLed with) TCI1 for downlink channels. As TCI1 is not associated with uplink channels (the unified TCI state indicates only downlink channels for TCI1), TCI1 is not used for uplink channels in the implicit TCI indication based on the CSI report.

The base station 110 may transmit another set of CMRs, as shown by reference number 730. In this case, there are no changes. The UE 120 may measure the CMRs and transmit a CSI report, as shown by reference number 735. In this CSI report, the CMRs has changed (CMR4, CMR2 and RSRP4, RSRP2). As shown by reference number 740, the base station 110 may transmit a confirmation of the CSI report, which may implicitly indicate use of TCI4. As shown by reference number 745, the base station 110 and the UE 120 may use a beam that corresponds to (is QCLed with) TCI4 for uplink channels (but not downlink channels) in the implicit TCI indication based on the CSI report.

As shown by reference number 750, the base station 110 may transmit CMRs. As shown by reference number 755, the UE 120 may transmit a CSI report with an order of CMR3 and CMR2. As shown by reference number 760, the base station 110 may transmit a confirmation of the CSI report to implicitly indicate TCI3 for downlink channels and TCI2 for uplink channels, as TCI3 is the best TCI state associated with downlink channels and TCI2 is the best TCI state associated with uplink channels. Accordingly, as shown by reference number 765, the base station 110 and the UE 120 may use TCI3 for downlink channels. As shown by reference number 770, TCI2 may be used for uplink channels.

In some aspects, the TCI state may be a legacy TCI state (Release 15 or 16). This may involve a DCI that schedules a communication on the PDSCH. If a TCI state is not available (e.g., not received in time) from a DCI that schedules the communication on the PDSCH, the UE 120 may use a beam, for the communication on the PDSCH, that corresponds to (is QCLed with) a TCI state that corresponds to a CMR reported in a CSI report. Although a DCI may be received, the DCI may not indicate a TCI state for a beam switch and thus the UE 120 may switch beams independent of an indication of a TCI state in DCI.

As indicated above, FIG. 7 is provided as an example. Other examples may differ from what is described with regard to FIG. 7.

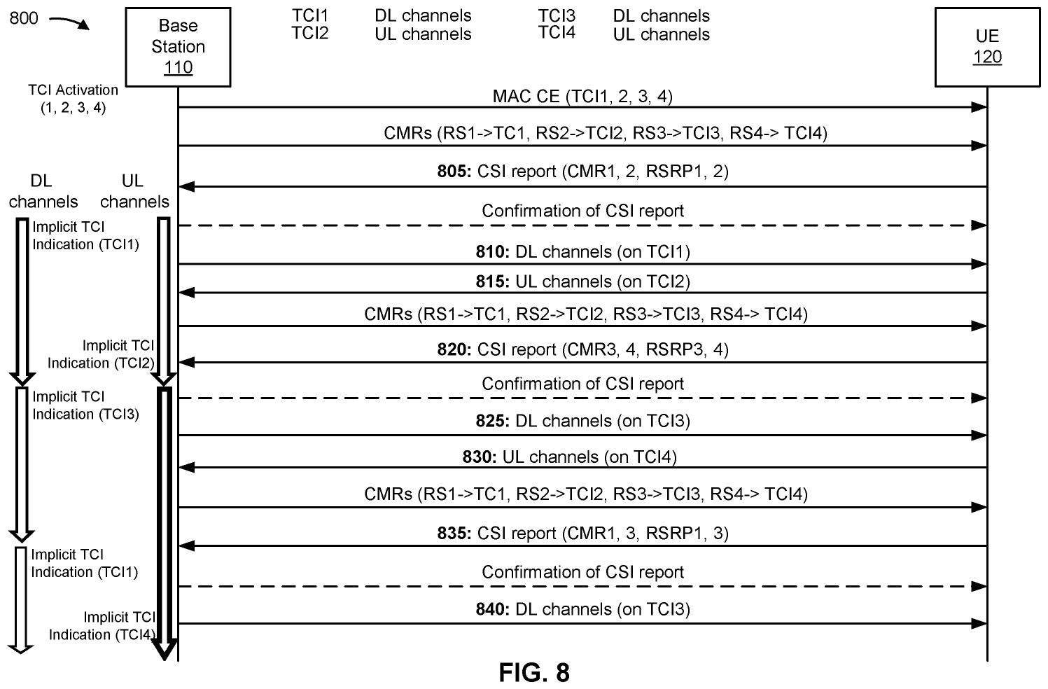

FIG. 8 is a diagram illustrating an example 800 associated with implicit beam switching, in accordance with the present disclosure. As shown in FIG. 8, a base station 110 and a UE 120 may communicate with one another.

Example 800 is another example of different TCI states corresponding to different sets of target channels. As shown by reference number 805, the UE 120 may transmit a CSI report that indicates CMR1 and CMR2 in order. As shown by reference number 810, the base station 110 and the UE 120 may use a beam that corresponds to (is QCLed with) TCI1 for downlink channels. As shown by reference number 815, the base station 110 and the UE 120 may use a beam that corresponds to TCI2 for uplink channels.

As shown by reference number 820, the UE 120 may transmit a CSI report indicating CMR3 and CMR4. Accordingly, as shown by reference number 825, the base station 110 and the UE 120 may use TCI3 for downlink channels. As shown by reference number 830, TCI4 may be used for uplink channels.

As shown by reference number 835, the UE 120 may transmit a CSI report indicating CMR1 and CMR3. Accordingly, as shown by reference number 840, the base station 110 and the UE 120 may use TCI3 for downlink channels. Even though TCI1 and TCI3 may both be used for downlink channels, TCI3 is the best beam for downlink channels. Neither TCI1 nor TCI3 are for uplink channels.

As indicated above, FIG. 8 is provided as an example. Other examples may differ from what is described with regard to FIG. 8.

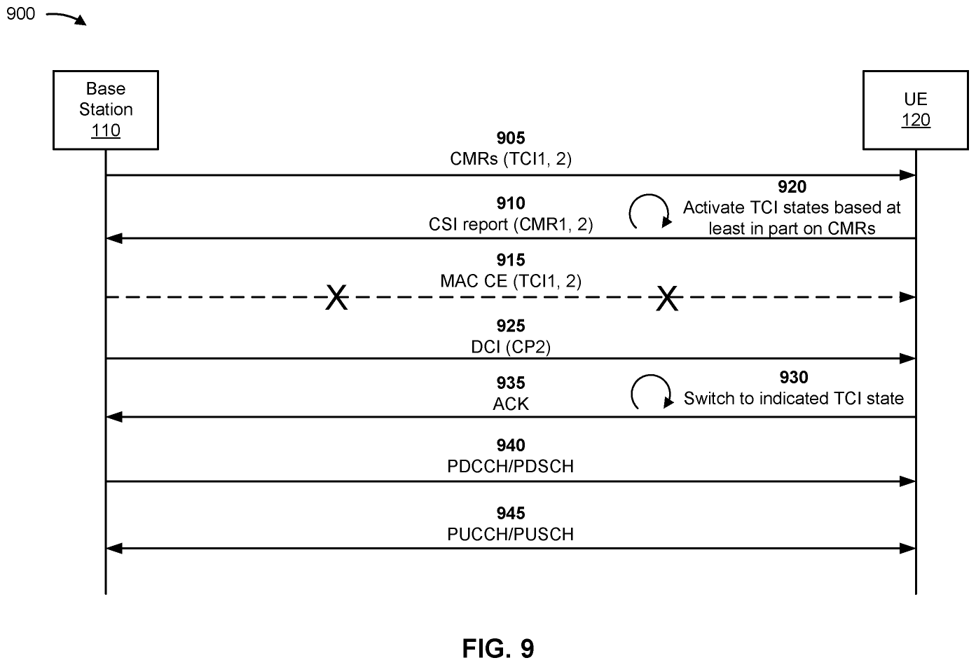

FIG. 9 is a diagram illustrating an example 900 associated with implicit TCI state activation, in accordance with the present disclosure. As shown in FIG. 9, a base station 110 and a UE 120 may communicate with one another.

In FIGS. 5-8, a MAC CE is used to activate TCI states. In some aspects, TCI state activation may be implicit. That is, the UE 120 may not receive a MAC CE to activate TCI states. Rather, the UE 120 may autonomously activate the TCI states that correspond to the reported CMRs that are received. There may be a one-to-one mapping of TCI states to CMRs (e.g., TCI states and reference signals of the CMRs may be equal in quantity). Each TCI codepoint may not have a pair of uplink and downlink TCI states. For example, TCI1 may be associated with uplink channels, and TCI2 may be associated with downlink channels.

As shown by reference number 905, the base station 110 may transmit CMRs (CMR1, CMR2) that correspond to TCI1 and TCI2. As shown by reference number 910, the UE 120 may transmit a CSI report indicating CMR1 and CMR2. As shown by reference number 915, the MAC CE that activates TCI states may be eliminated (whether the MAC CE is at reference number 915 or before reference number 905). As shown by reference number 920, the UE 120 may activate the TCI states based at least in part on the CMRs received as part of reference number 905 (and/or the CSI report of reference number 910). As a result of eliminating the MAC CE for TCI state activation, the base station 110 may conserve signaling resources and latency may be reduced.

As shown by reference number 925, when there are multiple TCIs activated by the CSI report, the base station 110 may indicate TCI codepoint 2 in DCI. The TCI codepoint in DCI may indicate one of multiple activated TCIs by the CSI report for the applicable channels. As shown by reference number 930, the UE 120 may switch to a beam that corresponds to the indicated TCI state. In example 900, the indicated TCI state is TCI2, which corresponds to TCI codepoint 2 based at least in part on the one-to-one mapping of the reported reference signals in the CSI report, activated TCIs at the UE 120, and the TCI codepoints in DCI. As shown by reference number 935, the UE 120 may transmit an ACK for the DCI. As shown by reference number 940, the base station 110 and the UE 120 may use the beam for communications on the PDCCH or the PDSCH. As shown by reference number 945, the base station 110 and the UE 120 may use the beam for communications on the PUCCH or the PUSCH.

In some aspects, TCI2 may be a unified TCI state. If implicit beam switching is to update DCI indicated by the unified TCI state, the UE 120 may find a unified TCI state that is QCLed with or has a source reference signal that is the reported reference signal. The UE 120 may determine applicable downlink and/or uplink channels according to the unified TCI state. If uplink channels are applicable, the UE 120 may also determine power control parameters based at least in part on the unified TCI state. In some aspects, the UE 120 may determine a TCI codepoint based at least in part on the unified TCI state. The mapping order of the reported reference signals and TCI codepoints may be preconfigured (e.g., based at least in part on TCI state ID). This may be applicable to single TRP operation.

As indicated above, FIG. 9 is provided as an example. Other examples may differ from what is described with regard to FIG. 9.

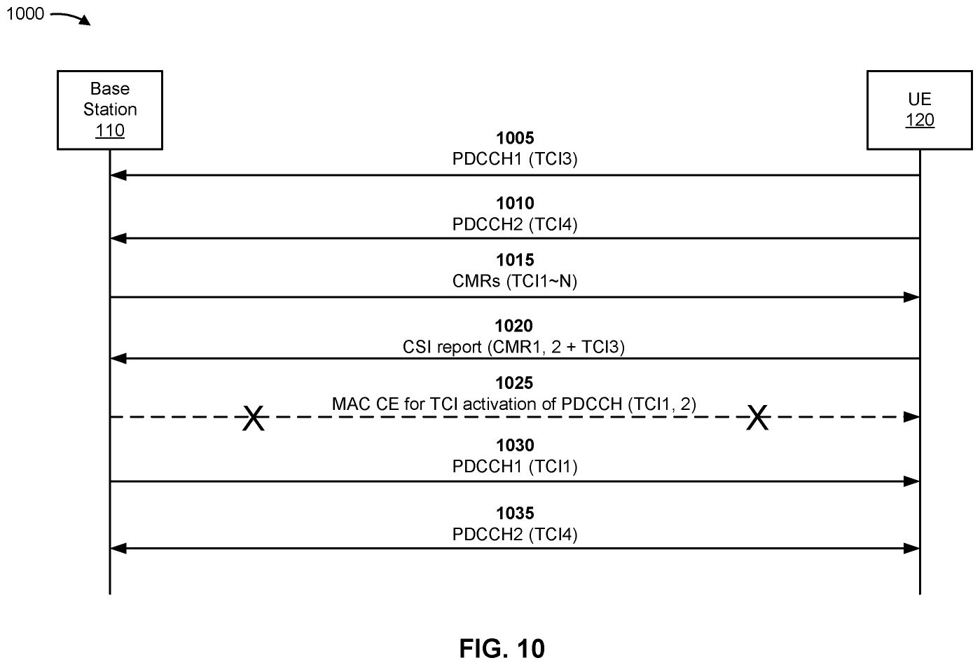

FIG. 10 is a diagram illustrating an example 1000 associated with implicit TCI state activation, in accordance with the present disclosure. As shown in FIG. 10, a base station 110 and a UE 120 may communicate with one another.

In some aspects, TCI2 may be a legacy TCI state that is associated with the PDSCH, the PDCCH, the PUCCH, or an SRS. As shown by reference number 1005, the base station 110 and the UE 120 may use TCI3 for communications on the PDCCH1 and, as shown by reference number 1010, TCI4 for communications on the PDCCH2. As shown by reference number 1015, the base station 110 may transmit CMRs for TCI states. As shown by reference number 1020, the UE 120 may report (e.g., in a CSI report) which TCI state information or spatial relation information (e.g., TCI3) is to be replaced by a new TCI state associated with CMRs reported in the CSI report. For example, the CSI report may report CMR1 and CMR2 and further indicate TCI3 for PDCCH. The MAC CE of reference number 1025 may be eliminated because the UE 120 may activate the TCI states that correspond to CMR1 and CMR2 received at reference number 1015.

A beam the corresponds to TCI3 may have been used for the communications on the PDCCH1, but now the base station 110 and the UE 120 may use a beam that corresponds to TCI1 for the communications on the PDCCH1, as shown by reference number 1030. As shown by reference number 1035, TCI4 is still used for the communications on the PDCCH2. In some aspects, the UE 120 may update all TCI states for the PDCCH, the PUCCH, and SRSs. In some aspects, the TCI state may apply to communications on the PDSCH. This may also be applicable to single TRP operation.

As indicated above, FIG. 10 is provided as an example. Other examples may differ from what is described with regard to FIG. 10.

FIG. 11 is a diagram illustrating an example process 1100 performed, for example, by a UE, in accordance with the present disclosure. Example process 1100 is an example where the UE (e.g., UE 120) performs operations associated with an implicit beam switch.

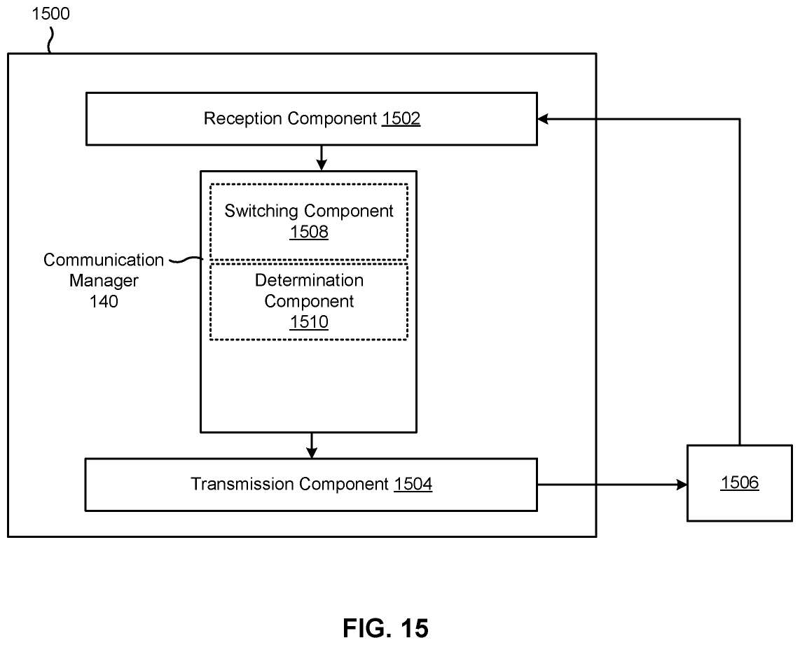

As shown in FIG. 11, in some aspects, process 1100 may include receiving a MAC CE that indicates one or more TCI states to be activated (block 1110). For example, the UE (e.g., using communication manager 140 and/or reception component 1502 depicted in FIG. 15) may receive a MAC CE that indicates one or more TCI states to be activated, as described above.

As further shown in FIG. 11, in some aspects, process 1100 may include receiving one or more CMRs that correspond to the one or more TCI states (block 1120). For example, the UE (e.g., using communication manager 140 and/or reception component 1502 depicted in FIG. 15) may receive one or more CMRs that correspond to the one or more TCI states, as described above.

As further shown in FIG. 11, in some aspects, process 1100 may include transmitting a CSI report for a first CMR of the one or more CMRs (block 1130). For example, the UE (e.g., using communication manager 140 and/or transmission component 1504 depicted in FIG. 15) may transmit a CSI report for a first CMR of the one or more CMRs, as described above.

As further shown in FIG. 11, in some aspects, process 1100 may include switching to a beam that is QCLed with a first TCI state, of the one or more TCI states, that corresponds to the first CMR, independent of receiving DCI that indicates switching to the first TCI state (block 1140). For example, the UE (e.g., using communication manager 140 and/or switching component 1508 depicted in FIG. 15) may switch to a beam that is QCLed with a first TCI state, of the one or more TCI states, that corresponds to the first CMR, independent of receiving DCI that indicates switching to the first TCI state, as described above.

Process 1100 may include additional aspects, such as any single aspect or any combination of aspects described below and/or in connection with one or more other processes described elsewhere herein.

In a first aspect, the CSI report includes a second CMR that corresponds to a second TCI state, and wherein the first CMR is first in order in the CSI report between the first CMR and the second CMR.

In a second aspect, alone or in combination with the first aspect, the first TCI state is associated with an uplink channel.

In a third aspect, alone or in combination with one or more of the first and second aspects, the second TCI state is associated with a downlink channel.

In a fourth aspect, alone or in combination with one or more of the first through third aspects, the first TCI state is associated with a downlink channel.

In a fifth aspect, alone or in combination with one or more of the first through fourth aspects, the second TCI state is associated with an uplink channel.

In a sixth aspect, alone or in combination with one or more of the first through fifth aspects, the first TCI state is a unified TCI state, and wherein the method further comprises determining that the first TCI state is associated with an uplink channel or a downlink channel based at least in part on the unified TCI state.

In a seventh aspect, alone or in combination with one or more of the first through sixth aspects, process 1100 includes determining power control parameters based at least in part on the unified TCI state if the unified TCI state is associated with an uplink channel.

In an eighth aspect, alone or in combination with one or more of the first through seventh aspects, the first TCI state is associated with a PDSCH if a TCI state is not received in DCI that schedules a communication for the PDSCH.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a base station, in accordance with the present disclosure. Example process 1200 is an example where the base station (e.g., base station 110) performs operations associated with an implicit beam switch.

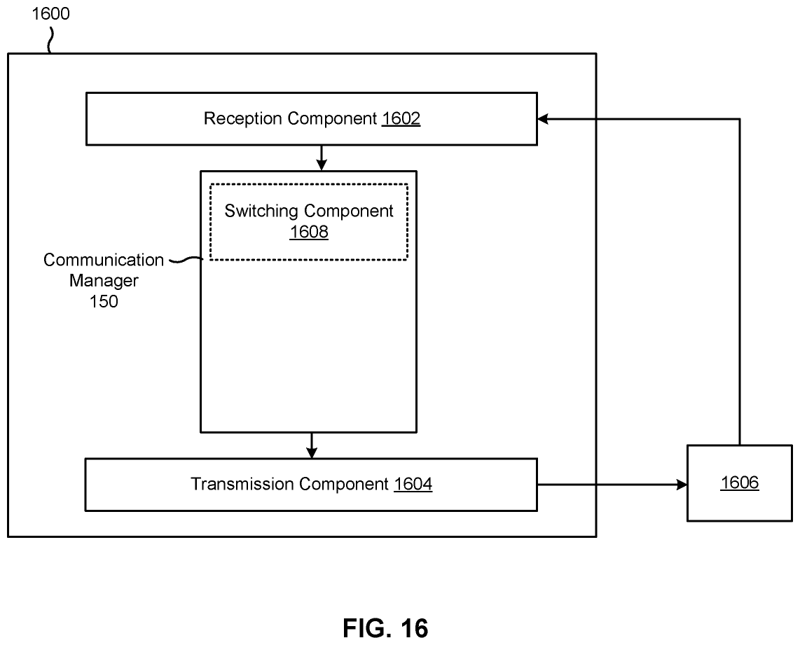

As shown in FIG. 12, in some aspects, process 1200 may include transmitting a MAC CE that indicates one or more TCI states to be activated (block 1210). For example, the base station (e.g., using communication manager 150 and/or transmission component 1604 depicted in FIG. 16) may transmit a MAC CE that indicates one or more TCI states to be activated, as described above.

As further shown in FIG. 12, in some aspects, process 1200 may include transmitting one or more CMRs that correspond to the one or more TCI states (block 1220). For example, the base station (e.g., using communication manager 150 and/or transmission component 1604 depicted in FIG. 16) may transmit one or more CMRs that correspond to the one or more TCI states, as described above.

As further shown in FIG. 12, in some aspects, process 1200 may include receiving a CSI report for a first CMR of the one or more CMRs (block 1230). For example, the base station (e.g., using communication manager 150 and/or reception component 1602 depicted in FIG. 16) may receive a CSI report for a first CMR of the one or more CMRs, as described above.

As further shown in FIG. 12, in some aspects, process 1200 may include switching to a beam for a first TCI state, of the one or more TCI states, that corresponds to the first CMR, independent of transmitting DCI that indicates the first TCI state (block 1240). For example, the base station (e.g., using communication manager 150 and/or switching component 1608 depicted in FIG. 16) may switch to a beam for a first TCI state, of the one or more TCI states, that corresponds to the first CMR, independent of transmitting DCI that indicates the first TCI state, as described above.

Process 1200 may include additional aspects, such as any single aspect or any combination of aspects described below and/or in connection with one or more other processes described elsewhere herein.

In a first aspect, the CSI report includes a second CMR that corresponds to a second TCI state, and wherein the first CMR is first in order in the CSI report between the first CMR and the second CMR.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., UE 120) performs operations associated with an TCI state activation.

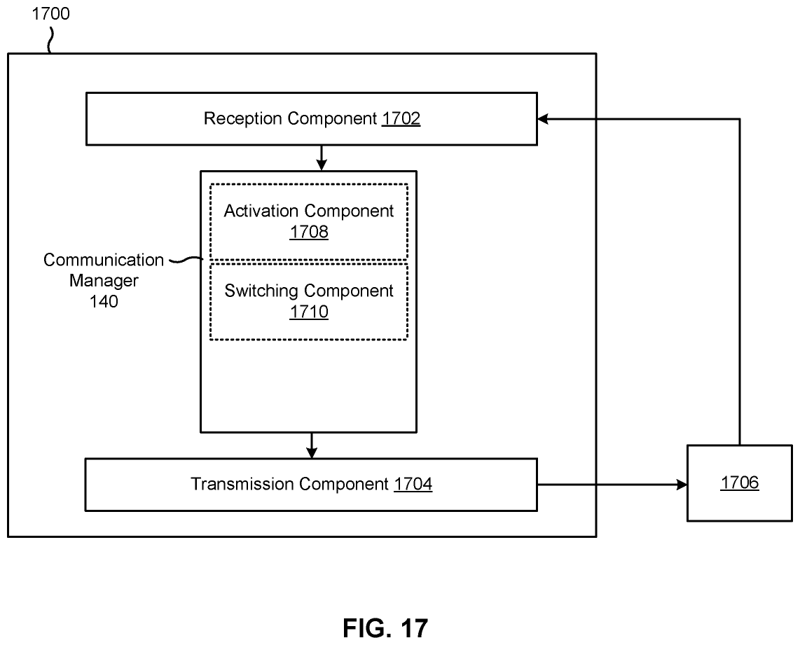

As shown in FIG. 13, in some aspects, process 1300 may include receiving one or more CMRs that correspond to one or more TCI states (block 1310). For example, the UE (e.g., using communication manager 140 and/or reception component 1702 depicted in FIG. 17) may receive one or more CMRs that correspond to one or more TCI states, as described above.

As further shown in FIG. 13, in some aspects, process 1300 may include activating the one or more TCI states independent of receiving a MAC CE that activates the one or more TCI states (block 1320). For example, the UE (e.g., using communication manager 140 and/or activation component 1708 depicted in FIG. 17) may activate the one or more TCI states independent of receiving a MAC CE that activates the one or more TCI states, as described above.

As further shown in FIG. 13, in some aspects, process 1300 may include transmitting a CSI report for a first CMR of the one or more CMRs (block 1330). For example, the UE (e.g., using communication manager 140 and/or transmission component 1704 depicted in FIG. 17) may transmit a CSI report for a first CMR of the one or more CMRs, as described above.

As further shown in FIG. 13, in some aspects, process 1300 may include receiving DCI that indicates a first TCI state, of the one or more TCI states, that corresponds to the first CMR (block 1340). For example, the UE (e.g., using communication manager 140 and/or reception component 1702 depicted in FIG. 17) may receive DCI that indicates a first TCI state, of the one or more TCI states, that corresponds to the first CMR, as described above.

As further shown in FIG. 13, in some aspects, process 1300 may include switching to a beam that is QCLed with the first TCI state (block 1350). For example, the UE (e.g., using communication manager 140 and/or switching component 1710 depicted in FIG. 17) may switch to a beam that is QCLed with the first TCI state, as described above.

Process 1300 may include additional aspects, such as any single aspect or any combination of aspects described below and/or in connection with one or more other processes described elsewhere herein.

In a first aspect, the CSI report includes a second CMR that corresponds to a second TCI, and wherein the first CMR is first in order in the CSI report between the first CMR and the second CMR.

In a second aspect, alone or in combination with the first aspect, the first TCI is associated with an uplink channel.

In a third aspect, alone or in combination with one or more of the first and second aspects, the second TCI is associated with a downlink channel.

In a fourth aspect, alone or in combination with one or more of the first through third aspects, the first TCI is associated with a downlink channel.

In a fifth aspect, alone or in combination with one or more of the first through fourth aspects, the second TCI is associated with an uplink channel.

In a sixth aspect, alone or in combination with one or more of the first through fifth aspects, the first TCI state is a unified TCI state, and wherein activating the one or more TCI states includes activating the first TCI state based at least in part on the unified TCI state.

In a seventh aspect, alone or in combination with one or more of the first through sixth aspects, the first TCI state is a unified TCI state, and wherein a TCI codepoint for the first TCI state is based at least in part on a mapping order associated with the unified TCI state.

In an eighth aspect, alone or in combination with one or more of the first through seventh aspects, the DCI schedules a physical downlink shared channel, wherein a TCI codepoint in the DCI is associated with the first TCI state, and wherein the first TCI state is mapped to the first CMR.

In a ninth aspect, alone or in combination with one or more of the first through eighth aspects, the DCI schedules a physical downlink control channel, a physical uplink control channel, or a sounding reference signal, and wherein the CSI report includes an indication of which TCI state is to be replaced by the first TCI state.

In a tenth aspect, alone or in combination with one or more of the first through ninth aspects, the DCI schedules a communication on a PDSCH, and wherein the first TCI state is for the communication on the PDSCH.

In an eleventh aspect, alone or in combination with one or more of the first through tenth aspects, the first TCI state is a unified TCI state, and wherein a TCI codepoint for the DCI is based at least in part on the unified TCI state.

In a twelfth aspect, alone or in combination with one or more of the first through eleventh aspects, the CSI report indicates which TCI state is to be replaced, and wherein the method further comprises replacing the TCI state that is to be replaced with the first TCI state.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a base station, in accordance with the present disclosure. Example process 1400 is an example where the base station (e.g., base station 110) performs operations associated with implicit TCI state activation.

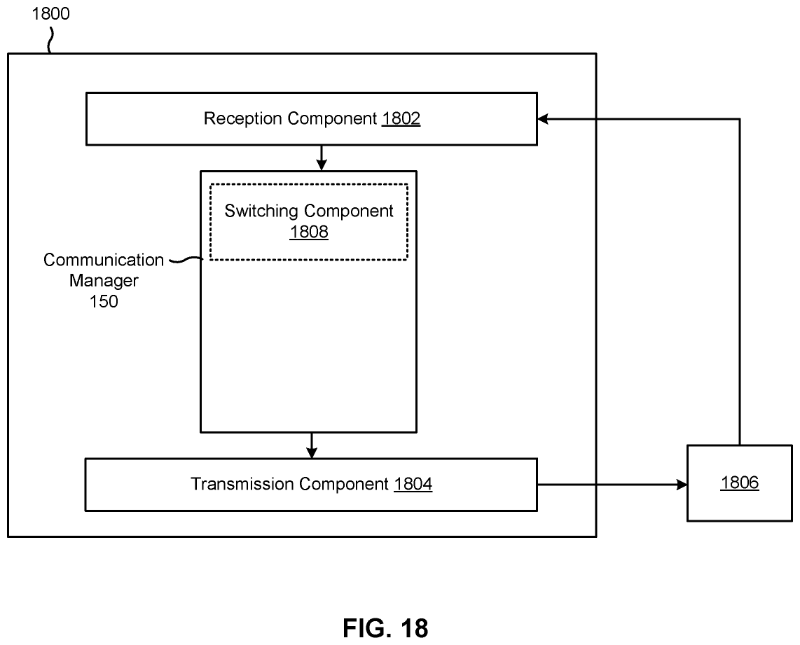

As shown in FIG. 14, in some aspects, process 1400 may include transmitting one or more CMRs that correspond to one or more TCI states (block 1410). For example, the base station (e.g., using communication manager 150 and/or transmission component 1804 depicted in FIG. 18) may transmit one or more CMRs that correspond to one or more TCI states, as described above.

As further shown in FIG. 14, in some aspects, process 1400 may include receiving, independent of transmitting a MAC CE, a CSI report for a first CMR of the one or more CMRs (block 1420). For example, the base station (e.g., using communication manager 150 and/or reception component 1802 depicted in FIG. 18) may receive, independent of transmitting a MAC CE, a CSI report for a first CMR of the one or more CMRs, as described above.

As further shown in FIG. 14, in some aspects, process 1400 may include transmitting DCI that indicates a first TCI state, of the one or more TCI states, that corresponds to the first CMR (block 1430). For example, the base station (e.g., using communication manager 150 and/or transmission component 1804 depicted in FIG. 18) may transmit DCI that indicates a first TCI state, of the one or more TCI states, that corresponds to the first CMR, as described above.

As further shown in FIG. 14, in some aspects, process 1400 may include switching to a beam for the first TCI state (block 1440). For example, the base station (e.g., using communication manager 150 and/or switching component 1808 depicted in FIG. 18) may switch to a beam for the first TCI state, as described above.

Process 1400 may include additional aspects, such as any single aspect or any combination of aspects described below and/or in connection with one or more other processes described elsewhere herein.

In a first aspect, the CSI report includes a second CMR that corresponds to a second TCI state, and wherein the first CMR is first in order in the CSI report between the first CMR and the second CMR.

In a second aspect, alone or in combination with the first aspect, the DCI schedules a physical downlink shared channel, wherein a TCI codepoint in the DCI is associated with the first TCI state, and wherein the first TCI state is one-to-one mapped with the first CMR.

In a third aspect, alone or in combination with one or more of the first and second aspects, the DCI schedules a physical downlink control channel, a physical uplink control channel, or a sounding reference signal, wherein the CSI report includes an indication of which TCI state is to be replaced by the first TCI state, and wherein a TCI codepoint in the DCI is associated with the first TCI state.

In a fourth aspect, alone or in combination with one or more of the first through third aspects, a TCI codepoint for the DCI is based at least in part on a unified TCI state that is associated with the first TCI state.

In a fifth aspect, alone or in combination with one or more of the first through fourth aspects, the CSI report includes an indication of which TCI state is to be replaced, and wherein the first TCI state is for the TCI state that is to be replaced.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a UE (e.g., UE 120), or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include a switching component 1508 and/or a determination component 1510, among other examples.

In some aspects, the apparatus 1500 may be configured to perform one or more operations described herein in connection with FIGS. 1-10. Additionally, or alternatively, the apparatus 1500 may be configured to perform one or more processes described herein, such as process 1100 of FIG. 11. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1506. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1506 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The reception component 1502 may receive a MAC CE that indicates one or more TCI states to be activated. The reception component 1502 may receive one or more CMRs that correspond to the one or more TCI states. The transmission component 1504 may transmit a CSI report for a first CMR of the one or more CMRs. The switching component 1508 may switch to a beam that is QCLed with a first TCI state, of the one or more TCI states, that corresponds to the first CMR, independent of receiving DCI that indicates switching to the first TCI state. The determination component 1510 may determine power control parameters based at least in part on the unified TCI state if the unified TCI state is associated with an uplink channel.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a base station (e.g., base station 110), or a base station may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 150. The communication manager 150 may include a switching component 1608, among other examples.

In some aspects, the apparatus 1600 may be configured to perform one or more operations described herein in connection with FIGS. 1-10. Additionally, or alternatively, the apparatus 1600 may be configured to perform one or more processes described herein, such as process 1200 of FIG. 12. In some aspects, the apparatus 1600 and/or one or more components shown in FIG. 16 may include one or more components of the base station described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1606. In some aspects, the reception component 1602 may include one or more antennas, a modem, a demodulator, a MIMO detector, a receive processor, a controller/processor, a memory, or a combination thereof, of the base station described in connection with FIG. 2.

The transmission component 1604 may transmit communications, such as reference signals, control information, data communications, or a combination thereof, to the apparatus 1606. In some aspects, one or more other components of the apparatus 1606 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the base station described in connection with FIG. 2. In some aspects, the transmission component 1604 may be co-located with the reception component 1602 in a transceiver.

The transmission component 1604 may transmit a MAC CE that indicates one or more TCI states to be activated. The transmission component 1604 may transmit one or more CMRs that correspond to the one or more TCI states. The reception component 1602 may receive a CSI report for a first CMR of the one or more CMRs. The switching component 1608 may switch to a beam for a first TCI state, of the one or more TCI states, that corresponds to the first CMR, independent of transmitting DCI that indicates the first TCI state.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication. The apparatus 1700 may be a UE (e.g., UE 120), or a UE may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 140. The communication manager 140 may include an activation component 1708 and/or a switching component 1710, among other examples.

In some aspects, the apparatus 1700 may be configured to perform one or more operations described herein in connection with FIGS. 1-10. Additionally, or alternatively, the apparatus 1700 may be configured to perform one or more processes described herein, such as process 1300 of FIG. 13. In some aspects, the apparatus 1700 and/or one or more components shown in FIG. 17 may include one or more components of the UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1706. In some aspects, the reception component 1702 may include one or more antennas, a modem, a demodulator, a MIMO detector, a receive processor, a controller/processor, a memory, or a combination thereof, of the UE described in connection with FIG. 2.

The transmission component 1704 may transmit communications, such as reference signals, control information, data communications, or a combination thereof, to the apparatus 1706. In some aspects, one or more other components of the apparatus 1706 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the UE described in connection with FIG. 2. In some aspects, the transmission component 1704 may be co-located with the reception component 1702 in a transceiver.

The reception component 1702 may receive one or more CMRs that correspond to one or more TCI states. The activation component 1708 may activate the one or more TCI states independent of receiving a MAC CE that activates the one or more TCI states. The transmission component 1704 may transmit a CSI report for a first CMR of the one or more CMRs. The reception component 1702 may receive DCI that indicates a first TCI state, of the one or more TCI states, that corresponds to the first CMR. The switching component 1710 may switch to a beam that is QCLed with the first TCI state.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

FIG. 18 is a diagram of an example apparatus 1800 for wireless communication. The apparatus 1800 may be a base station (e.g., base station 110), or a base station may include the apparatus 1800. In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a base station, or another wireless communication device) using the reception component 1802 and the transmission component 1804. As further shown, the apparatus 1800 may include the communication manager 150. The communication manager 150 may a switching component 1808, among other examples.

In some aspects, the apparatus 1800 may be configured to perform one or more operations described herein in connection with FIGS. 1-10. Additionally, or alternatively, the apparatus 1800 may be configured to perform one or more processes described herein, such as process 1400 of FIG. 14. In some aspects, the apparatus 1800 and/or one or more components shown in FIG. 18 may include one or more components of the base station described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1806. In some aspects, the reception component 1802 may include one or more antennas, a modem, a demodulator, a MIMO detector, a receive processor, a controller/processor, a memory, or a combination thereof, of the base station described in connection with FIG. 2.

The transmission component 1804 may transmit communications, such as reference signals, control information, data communications, or a combination thereof, to the apparatus 1806. In some aspects, one or more other components of the apparatus 1806 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the base station described in connection with FIG. 2. In some aspects, the transmission component 1804 may be co-located with the reception component 1802 in a transceiver.

The transmission component 1804 may transmit one or more CMRs that correspond to one or more TCI states. The reception component 1802 may receive, independent of transmitting a MAC CE, a CSI report for a first CMR of the one or more CMRs. The transmission component 1804 may transmit DCI that indicates a first TCI state, of the one or more TCI states, that corresponds to the first CMR. The switching component 1808 may switch to a beam for the first TCI state.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

The following provides an overview of some Aspects of the present disclosure:

Aspect 1: A method of wireless communication performed by a user equipment (UE), comprising: receiving a medium access control control element (MAC CE) that indicates one or more transmission configuration indicator (TCI) states to be activated; receiving one or more channel measurement resources (CMRs) that correspond to the one or more TCI states; transmitting a channel state information (CSI) report for a first CMR of the one or more CMRs; and switching to a beam that is quasi-co-located (QCLed) with a first TCI state, of the one or more TCI states, that corresponds to the first CMR, independent of receiving downlink control information (DCI) that indicates switching to the first TCI state.

Aspect 2: The method of Aspect 1, wherein the CSI report includes a second CMR that corresponds to a second TCI state, and wherein the first CMR is first in order in the CSI report between the first CMR and the second CMR.

Aspect 3: The method of Aspect 2, wherein the first TCI state is associated with an uplink channel.

Aspect 4: The method of Aspect 3, wherein the second TCI state is associated with a downlink channel.

Aspect 5: The method of Aspect 2, wherein the first TCI state is associated with a downlink channel.

Aspect 6: The method of Aspect 5, wherein the second TCI state is associated with an uplink channel.

Aspect 7: The method of any of Aspects 1-6, wherein the first TCI state is a unified TCI state, and wherein the method further comprises determining that the first TCI state is associated with an uplink channel or a downlink channel based at least in part on the unified TCI state.

Aspect 8: The method of Aspect 7, further comprising determining power control parameters based at least in part on the unified TCI state if the unified TCI state is associated with an uplink channel.

Aspect 9: The method of any of Aspects 1-8, wherein the first TCI state is associated with a physical downlink shared channel (PDSCH) if a TCI state is not received in DCI that schedules a communication for the PDSCH.

Aspect 10: A method of wireless communication performed by a base station, comprising: transmitting a medium access control control element (MAC CE) that indicates one or more transmission configuration indicator (TCI) states to be activated; transmitting one or more channel measurement resources (CMRs) that correspond to the one or more TCI states; receiving a channel state information (CSI) report for a first CMR of the one or more CMRs; and switching to a beam for a first TCI state, of the one or more TCI states, that corresponds to the first CMR, independent of transmitting downlink control information (DCI) that indicates the first TCI state.

Aspect 11: The method of Aspect 10, wherein the CSI report includes a second CMR that corresponds to a second TCI state, and wherein the first CMR is first in order in the CSI report between the first CMR and the second CMR.

Aspect 12: A method of wireless communication performed by a user equipment (UE), comprising: receiving one or more channel measurement resources (CMRs) that correspond to one or more transmission configuration indicator (TCI) states; activating the one or more TCI states independent of receiving a medium access control control element (MAC CE) that activates the one or more TCI states; transmitting a channel state information (CSI) report for a first CMR of the one or more CMRs; receiving downlink control information (DCI) that indicates a first TCI state, of the one or more TCI states, that corresponds to the first CMR; and switching to a beam that is quasi-co-located (QCLed) with the first TCI state.

Aspect 13: The method of Aspect 12, wherein the CSI report includes a second CMR that corresponds to a second TCI, and wherein the first CMR is first in order in the CSI report between the first CMR and the second CMR.

Aspect 14: The method of Aspect 13, wherein the first TCI is associated with an uplink channel.

Aspect 15: The method of Aspect 14, wherein the second TCI is associated with a downlink channel.

Aspect 16: The method of Aspect 13, wherein the first TCI is associated with a downlink channel.

Aspect 17: The method of Aspect 16, wherein the second TCI is associated with an uplink channel.

Aspect 18: The method of any of Aspects 12-17, wherein the first TCI state is a unified TCI state, and wherein activating the one or more TCI states includes activating the first TCI state based at least in part on the unified TCI state.

Aspect 19: The method of Aspect 18, wherein the first TCI state is a unified TCI state, and wherein a TCI codepoint for the first TCI state is based at least in part on a mapping order associated with the unified TCI state.

Aspect 20: The method of Aspect 18, wherein the DCI schedules a physical downlink shared channel, wherein a TCI codepoint in the DCI is associated with the first TCI state, and wherein the first TCI state is mapped to the first CMR.

Aspect 21: The method of Aspect 18, wherein the DCI schedules a physical downlink control channel, a physical uplink control channel, or a sounding reference signal, and wherein the CSI report includes an indication of which TCI state is to be replaced by the first TCI state.

Aspect 22: The method of Aspect 18, wherein the DCI schedules a communication on a physical downlink shared channel (PDSCH), and wherein the first TCI state is for the communication on the PDSCH.

Aspect 23: The method of Aspect 18, wherein the first TCI state is a unified TCI state, and wherein a TCI codepoint for the DCI is based at least in part on the unified TCI state.

Aspect 24: The method of Aspect 18, wherein the CSI report indicates which TCI state is to be replaced, and wherein the method further comprises replacing the TCI state that is to be replaced with the first TCI state.

Aspect 25: A method of wireless communication performed by a base station, comprising: transmitting one or more channel measurement resources (CMRs) that correspond to one or more transmission configuration indicator (TCI) states; receiving, independent of transmitting a medium access control control element (MAC CE), a channel state information (CSI) report for a first CMR of the one or more CMRs; transmitting downlink control information (DCI) that indicates a first TCI state, of the one or more TCI states, that corresponds to the first CMR; and switching to a beam for the first TCI state.

Aspect 26: The method of Aspect 25, wherein the CSI report includes a second CMR that corresponds to a second TCI state, and wherein the first CMR is first in order in the CSI report between the first CMR and the second CMR.

Aspect 27: The method of Aspect 25 or 26, wherein the DCI schedules a physical downlink shared channel, wherein a TCI codepoint in the DCI is associated with the first TCI state, and wherein the first TCI state is one-to-one mapped with the first CMR.

Aspect 28: The method of any of Aspects 25-27, wherein the DCI schedules a physical downlink control channel, a physical uplink control channel, or a sounding reference signal, wherein the CSI report includes an indication of which TCI state is to be replaced by the first TCI state, and wherein a TCI codepoint in the DCI is associated with the first TCI state.

Aspect 29: The method of any of Aspects 25-28, wherein a TCI codepoint for the DCI is based at least in part on a unified TCI state that is associated with the first TCI state.

Aspect 30: The method of any of Aspects 25-29, wherein the CSI report includes an indication of which TCI state is to be replaced, and wherein the first TCI state is for the TCI state that is to be replaced.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
memory; and
one or more processors coupled to the memory, the one or more processors configured to:
receive a medium access control control element (MAC CE) that indicates one or more transmission configuration indicator (TCI) states to be activated;
receive one or more channel measurement resources (CMRs) that correspond to the one or more TCI states;
transmit a channel state information (CSI) report for a first CMR of the one or more CMRs; and
switch to a beam that is quasi-co-located (QCLed) with a first TCI state, of the one or more TCI states, that corresponds to the first CMR, independent of receiving downlink control information (DCI) that indicates switching to the first TCI state.

2. The UE of claim 1, wherein the CSI report includes a second CMR that corresponds to a second TCI state, and wherein the first CMR is first in order in the CSI report between the first CMR and the second CMR.

3. The UE of claim 2, wherein the first TCI state is associated with an uplink channel.

4. The UE of claim 3, wherein the second TCI state is associated with a downlink channel.

5. The UE of claim 2, wherein the first TCI state is associated with a downlink channel.

6. The UE of claim 5, wherein the second TCI state is associated with an uplink channel.

7. The UE of claim 1, wherein the first TCI state is a unified TCI state, and wherein the one or more processors are configured to determine that the first TCI state is associated with an uplink channel or a downlink channel based at least in part on the unified TCI state.

8. The UE of claim 7, wherein the one or more processors are configured to determine power control parameters based at least in part on the unified TCI state if the unified TCI state is associated with an uplink channel.

9. The UE of claim 1, wherein the first TCI state is associated with a physical downlink shared channel (PDSCH) if a TCI state is not received in DCI that schedules a communication for the PDSCH.

10. A base station for wireless communication, comprising:
memory; and
one or more processors coupled to the memory, the one or more processors configured to:
transmit a medium access control control element (MAC CE) that indicates one or more transmission configuration indicator (TCI) states to be activated;
transmit one or more channel measurement resources (CMRs) that correspond to the one or more TCI states;
receive a channel state information (CSI) report for a first CMR of the one or more CMRs; and
switch to a beam for a first TCI state, of the one or more TCI states, that corresponds to the first CMR, independent of transmitting downlink control information (DCI) that indicates the first TCI state.

11. The base station of claim 10, wherein the CSI report includes a second CMR that corresponds to a second TCI state, and wherein the first CMR is first in order in the CSI report between the first CMR and the second CMR.

12. A user equipment (UE) for wireless communication, comprising:
memory; and
one or more processors coupled to the memory, the one or more processors configured to:
receive one or more channel measurement resources (CMRs) that correspond to one or more transmission configuration indicator (TCI) states;
activate the one or more TCI states independent of receiving a medium access control control element (MAC CE) that activates the one or more TCI states;
transmit a channel state information (CSI) report for a first CMR of the one or more CMRs;
receive downlink control information (DCI) that indicates a first TCI state, of the one or more TCI states, that corresponds to the first CMR; and
switch to a beam that is quasi-co-located (QCLed) with the first TCI state.

13. The UE of claim 12, wherein the CSI report includes a second CMR that corresponds to a second TCI, and wherein the first CMR is first in order in the CSI report between the first CMR and the second CMR.

14. The UE of claim 13, wherein the first TCI is associated with an uplink channel.

15. The UE of claim 14, wherein the second TCI is associated with a downlink channel.

16. The UE of claim 13, wherein the first TCI is associated with a downlink channel.

17. The UE of claim 16, wherein the second TCI is associated with an uplink channel.

18. The UE of claim 12, wherein the first TCI state is a unified TCI state, and wherein the one or more processors are configured to activate the first TCI state based at least in part on the unified TCI state.

19. The UE of claim 18, wherein the first TCI state is a unified TCI state, and wherein a TCI codepoint for the first TCI state is based at least in part on a mapping order associated with the unified TCI state.

20. The UE of claim 18, wherein the DCI schedules a physical downlink shared channel, wherein a TCI codepoint in the DCI is associated with the first TCI state, and wherein the first TCI state is mapped to the first CMR.

21. The UE of claim 18, wherein the DCI schedules a physical downlink control channel, a physical uplink control channel, or a sounding reference signal, and wherein the CSI report includes an indication of which TCI state is to be replaced by the first TCI state.

22. The UE of claim 18, wherein the DCI schedules a communication on a physical downlink shared channel (PDSCH), and wherein the first TCI state is for the communication on the PDSCH.

23. The UE of claim 18, wherein the first TCI state is a unified TCI state, and wherein a TCI codepoint for the DCI is based at least in part on the unified TCI state.

24. The UE of claim 18, wherein the CSI report indicates which TCI state is to be replaced, and wherein the one or more processors are configured to replace the TCI state that is to be replaced with the first TCI state.

25. A base station for wireless communication, comprising:
memory; and
one or more processors coupled to the memory, the one or more processors configured to:
transmit one or more channel measurement resources (CMRs) that correspond to one or more transmission configuration indicator (TCI) states;
receive, independent of transmitting a medium access control control element (MAC CE), a channel state information (CSI) report for a first CMR of the one or more CMRs;
transmit downlink control information (DCI) that indicates a first TCI state, of the one or more TCI states, that corresponds to the first CMR; and
switch to a beam for the first TCI state.

26. The base station of claim 25, wherein the CSI report includes a second CMR that corresponds to a second TCI state, and wherein the first CMR is first in order in the CSI report between the first CMR and the second CMR.

27. The base station of claim 25, wherein the DCI schedules a physical downlink shared channel, wherein a TCI codepoint in the DCI is associated with the first TCI state, and wherein the first TCI state is one-to-one mapped with the first CMR.

28. The base station of claim 25, wherein the DCI schedules a physical downlink control channel, a physical uplink control channel, or a sounding reference signal, wherein the CSI report includes an indication of which TCI state is to be replaced by the first TCI state, and wherein a TCI codepoint in the DCI is associated with the first TCI state.

29. The base station of claim 25, wherein a TCI codepoint for the DCI is based at least in part on a unified TCI state that is associated with the first TCI state.

30. The base station of claim 25, wherein the CSI report includes an indication of which TCI state is to be replaced, and wherein the first TCI state is for the TCI state that is to be replaced.

31-34. (canceled)
